(19) United States
(12) Patent Application Publication
(10) Pub. No.: US 2001/0000976 A1
(43) Pub. Date: May 10, 2001

(54) Reflexive light source detector

(76) Inventor: Chen Tsung-Wei, Tainan City (TW)

Correspondence Address: Chen Tsung-Wei, 9F3R, No. 210, Chung Hsueh Rd., Tainan City, TW

(21) Appl. No.: 09/746,664

(22) Filed: Dec. 21, 2000

(30) Foreign Application Priority Data
Oct. 21, 1999 (TW) 88217927

(51) Int. Cl. G01J 1/42

(52) U.S. Cl. 356/221; 340/600

(57) ABSTRACT

A reflexive light source detector produces different light source value when a printing matter or something receives light so that a reader may receive different stimulus on his/her eyes and then adjust the light source to get proper light for reading or seeing. The detector includes a housing, and a photosensitive element contained in the housing and to be positioned to form an angle θ toward the printing matter so as to let the light source light the printing matter or something and to measure the reflected light by the printing mater or something receiving the light from the light source. Then the detector can decide whether the reflected light is proper for reading or not, based on a preset value, protecting reader's eyes from becoming myopia.

### BACKGROUND OF THE INVENTION

1. This invention relates to a reflexive light source detector, particularly to one capable to detect the quantity of reflected light on a printing matter, telling a reader whether the light is proper or not, also capable to detect whether a light appliance on market at present flickers or not, and reminding the reader to rest eyes for some minutes regularly.

2. Recently school children in our country have myopia percentage higher than any other country in the world, resulting in inconvenience and troubles in their daily lives.

3. A large part of population of our country having myopia may be caused by small area of their living space, frequent watching of TV, and reading and writing in weak lit rooms. As our economy has been growing better and better, elevating lighting equipment in every house is useful in reducing myopia percentage and protecting eyesight of the next generation. Nevertheless, too strong or too weak light practically makes harm to healthy eyes, and fluorescent lamps, tungsten lamps, or power-saving lamps offers different brightness of light, and people's eyes receive them in different degrees. Although light appliances on market bear the mark of having eye-protecting function, but in fact there functions are not so good as advertised. So users are often at a loss in deciding to use which lamp to suit their eyes in reading.

4. In addition, lamps on market are also marked not to flicker, but it is doubtful whether it is true or not for users to know, without published report of random test carried out by the consumer protection fund.

### SUMMARY OF THE INVENTION

5. The objective of the invention is to offer a reflexive light source detector capable to detect reflected quantity of light, to detect whether a light appliance flickers or not, and to remind a reader to stop reading for some minutes regularly.

6. A first feature of the invention is photosensitive element positioned in a θ angle toward a printing matter, having detecting function of reflected light from the printing matter.

7. A second feature of the invention is an advantage that the reflected light directly stimulates the eyes of a reader/viewer so that the light source may be adjusted to make the reflected light suitable for reading.

8. A third feature of the invention is a function of detecting whether a light appliance flickers or not, for reference for consumers to decide to buy or not.

9. A fourth feature of the invention is a function of counting time to remind a reader to take a rest regularly to protect his/her eyes.

### BRIEF DESCRIPTION OF DRAWINGS

10. This invention will be better understood by referring to the accompanying drawings, wherein:

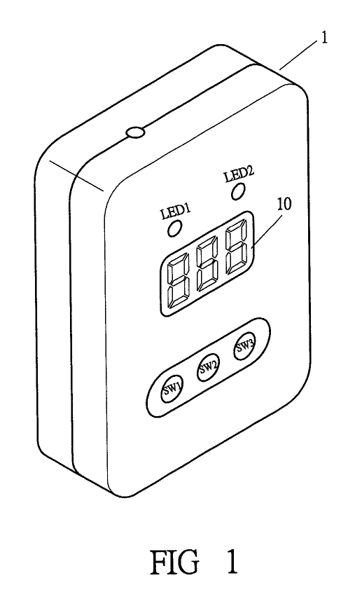

11. FIG. 1 is a perspective view of a reflexive light source detector in the present invention.

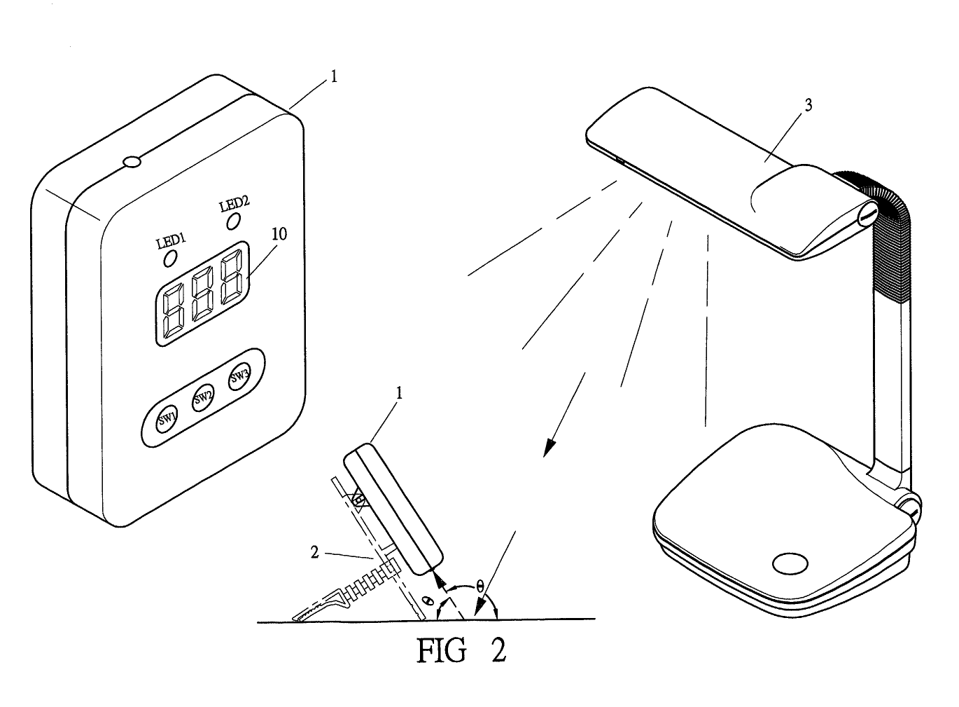

12. FIG. 2 is a perspective view of the reflexive light source detector positioned relative to a light source in the present invention.

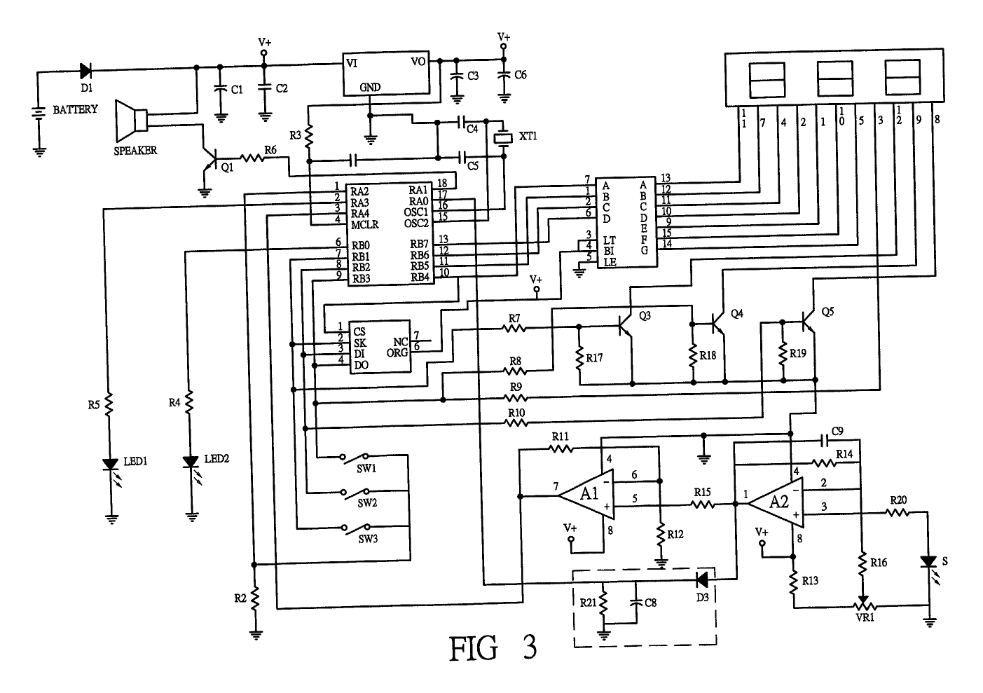

13. FIG. 3 is a diagram of an electronic circuit of the reflexive light source detector in the present invention; and,

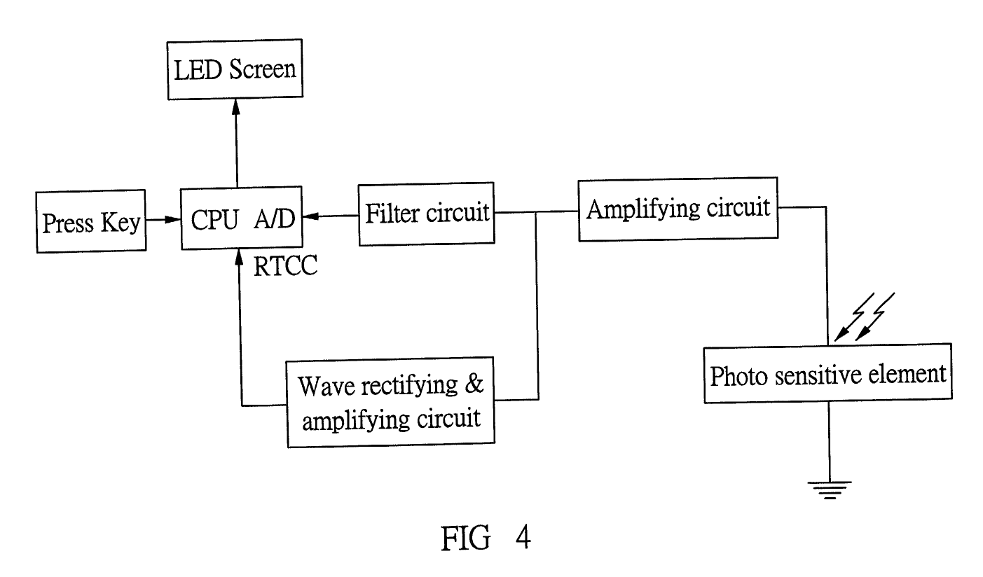

14. FIG. 4 is a block diagram of the reflexive light source detector in the present invention.

### DETAILED DESCRIPTION OF THE PREFERRED EMBODIMENT

15. A preferred embodiment of a reflexive light source detector in the present invention, as shown in FIGS. 1 and 2, includes a housing 1 consisting of two half housings combined together, a control base board having an electronic circuit shown in FIG. 3, a screen 10 in a surface of the housing 1 for showing numerals, two signal lamps LED1, LED2 positioned on the screen 10, and plural switches SW1, SW2, SW3 provided under the screen 10 and reduced or increased according to functions needed. The switches and the operative functions of the detector have the following relations.

16. 1. When the reflexive light source detector is powered for the first time, it is in the turned-ff condition, with the LED1 lit up.

17. 2. When the switch SW1 is pressed: the detector is turned on, performing light test.

18. (a) SW2: setting warning ON/OFF (higher or lower than the preset value)→a fluorescent lamp.

19. (b) SW3: setting warning ON/OFF (higher or lower than the preset value)→a tungsten lamp.

20. 3. When SW1 is pressed: the detector indicates to test a light appliance (with the LED2 lit up), with SW1 showing a new value.

21. (a) SW2: fixing the flickering value.

22. (b) SW3: clearing the flickering value, and newly reading a flickering value.

23. 4. Press SW1 again, letting the detector move in time reverse counting function, (LED1 and LED2 flicker), giving out warning sound when the time is up.

24. (a) SW2: choosing set time 20, 30, 40, 50 or 60 minutes.

25. (b) SW3: temporarily stopping time counting/start again (operating conciliatorily).

26. 5. Press SW1 again, letting the detector stop.

27. A foot frame 2 is provided at a rear side of the housing 1 of the reflexive light source detector, capable to adjust its angle of the detector toward a light source, in order to adjust the angle θ between the position of the photosensitive element (S) of the detector and the printing matter a user is reading to form preferably 30-60 degrees. But the angle θ can also be adjusted larger than 60 degrees or smaller than 30 degrees if needed. The angle θ has a function to let the light source (for example, a table lamp) reflected by a printing matter or something to correctly reach the eyes of a user. So the angle θ is the direction of the light a person receives after the light of the light source reflected by the printing matter or something. So the light value measured by the photosensitive element will be shown on the screen 10, different for white light (of a fluorescent lamp) and yellow light (of a tungsten lamp), and in the invention this value is taken from the comparatively proper brightness set by ophthalmologists at present. Then a user can freely adjust the light source to protect the eyes in reading by means of the detector in the invention.

28. Next, the photosensitive element S shown in FIG. 3 may produce voltage signal output, which it then enlarged by an OP amplifying circuit composed of A2 marked in FIG. 3, treated by a CPU, converted into digital signal by an A/D converter (shown in FIG. 3), calculated by a calculating circuit, and then its value shown on the screen 10. In case the value of the reflected light is higher or lower than the proper value, a speaker sounds out so that the user may adjust the light source 3. Then press SW1 to check if the light appliance flickers or not, and then the photosensitive element S measures the voltage signal the light source produces, which is then treated by the OP amplifying circuit and also by the OP amplifying circuit to check flickering signal, then treated by the CPU, then converted into digital signals by A/D converter and then shown on the screen to indicate if the light source flickers or not. So a user himself can test a lamp appliance in buying it. When SW1 is pressed again, the detector moves into time reverse counting condition, a warning sound is given out to warn the user to rest eyes for a while. Therefore, the detector in the invention surely is capable to detect if the light source for reading is proper or not, to check whether the light source flickers or not, and to remind the user to rest eyes by reverse counting time.

29. While the preferred embodiment of the invention has been described, it will be recognized and understood that various modifications may be made therein and the appended claims are intended to cover all such modifications that may fall within the spirit and scope of the invention.

What is claimed is:

1. A reflexive light source detector comprising a housing, a photosensitive element contained in said housing, said photosensitive element forming an angle θ toward a light source, a printing matter reflecting light when receives light from said light source, said photosensitive element capable to detect reflected light by said printing matter, a proper light value set in said detector to decide whether said light source and said reflected light by said printing matter receiving light from said light source are proper for a reader to read or not, said detector showing said light value on a screen to the reader so as to adjust said light source in case of need for protecting eyes from becoming myopia.

2. A reflective light source detector comprising a photosensitive element capable to produce a voltage signal output after receiving reflected light from a light source, an OP amplifying circuit composed of A2 amplifying said voltage signal output, then treated by a CPU and then converted into digital signal by an A/D converter, a calculating circuit calculating said digital signal, which is then shown on a screen, said light source having to be adjusted in case that said digital value showing on said screen is higher or lower than a preset proper value, said voltage signal produced by said photosensitive element being treated by said OP amplifying circuit composed of A2 and another OP amplifying circuit composed of A1 to analyze flickering signal in said voltage signal and then treated by said CPU, said flickering signal treated by said CPU being shown in numerals on said screen to decide whether said light source flickers or not; said detector moving into reverse counting time condition when said SW1 is pressed again, a speaker sounding out warning so as to remind a user to rest eyes for a while when the time is up.
